(19) United States
(12) Patent Application Publication
(10) Pub. No.: US 2010/0115201 A1
(43) Pub. Date: May 6, 2010

(54) AUTHENTICABLE USB STORAGE DEVICE AND METHOD THEREOF

(75) Inventor: Yu-jen Hsu, Taipei City (TW)

Correspondence Address: KIRTON AND MCCONKIE, 60 EAST SOUTH TEMPLE,, SUITE 1800, SALT LAKE CITY, UT, 84111, US

(73) Assignee: GENESYS LOGIC, INC., Shindian City (TW)

(21) Appl. No.: 12/368,696

(22) Filed: Feb. 10, 2009

(30) Foreign Application Priority Data
Nov. 6, 2008 (TW) 097142905

(51) Int. Cl. G06F 12/00; G06F 13/00; G06F 12/14

(52) U.S. Cl. 711/115; 710/300; 711/163; 711/E12.001; 711/E12.091; 711/E12.008; 711/103

(57) ABSTRACT

An external storage device accessible to a host is proposed. The external storage device includes a memory device and a processing unit. The memory device includes a protected area for storing an authentication application, a public area for storing an unlock application, and a reserved area for storing authentication information. The processing unit is used for performing an identification request from the authentication application. When the authentication information is confirmed, the host is allowed to access the protected area of the external storage device, accordingly.

### BACKGROUND OF THE INVENTION

1. Field of the Invention

The present invention relates to a universal serial bus (USB) storage device and related security method, and more specifically, to a USB storage device to be accessible to a host based on an existence of an authenticable data and related security method for the same.

2. Description of the Related Art

Along with rapid development of the storage media, the traditional hard disk has larger memory space, but is not portable enough. The soft discs, tapes or compact disks are easily portable, but their limited storage space confines the size of stored data.

To improve the defects of these traditional storage media, the flash memory has been highlighted for recent years. The flash memory is a non-volatile memory, which can keep written data even if the power supply is off. Among other storage media such as the hard disk, the soft disk, or the tape, the flash memory has such characteristics as small size, light weight, anti-vibration, non-mechanical sluggishness in access, and low power consumption. Because of these characteristics, the flash memory is widely used as data storage media in consuming electronic products, embedded systems and portable computers.

Many storage devices with flash memory use conventional universal serial bus On-The-Go(OTG) device as a communicating interface with the host. Although USB storage device can be widely accessed by the host, all these external storage devices are short of a secure protection measure to prevent other people's copying. If the user simply sets an authorizing password, once forgetting the password, the data stored in the flash memory is inaccessible. On the other hand, in a modern life, people's activities greatly depend on computers such as online shopping, electrically-wired transferring and so on, which need passwords for identification. For convenience, users may utilize a single password in various aspects of life. As a consequence, once the password is cracked, the user has to change the password in all other aspects to prevent more loss. However, if the user sets different password for each use, these passwords impose heavy burden on the user's brain. It is therefore the storage device producer's goal to develop a storage device of the function of auto-verification with the set password without entering the password.

### SUMMARY OF THE INVENTION

Briefly summarized, an external storage device of controlling an access to a host is provided. The external storage device comprises a memory device and a processing unit. The memory device comprises one or more protected areas for storing an authentication application, and a reserved area for storing authentication information. The processing unit is used for performing an identification request from the authentication application, and for allowing the host to access the protected area of the external storage device when the authentication information is confirmed.

In one aspect, the memory device is a hard disc drive. The memory device further comprises a transforming interface for transforming data stored in the hard disc drive into ATA/SATA format.

In another aspect, the authentication information comprises a managing table for recording start logical block addresses and storing sizes of the one or more protected areas. Further, the authentication information comprises a trusted device table for recording one or more specific information and corresponding authorizing passwords. The specific information comprises MAC address of the host, a serial number of a software revision of an operating system in the host, an OEM ID of a motherboard of the host, or a combination thereof. The processing unit is used for allowing the host to access the protected area of the external storage device when the authorizing password of authentication information is confirmed. The trusted device table further comprises an allowable use count of the authorizing password. The trusted device table further comprises a valid period of the authorizing password indicating to an expiration date of the authorizing password.

In still another aspect, the external storage device further comprises a public area for storing unlock data, and a USB interface for transforming data from the processing unit into a USB format.

According to the present invention, a method of controlling an access to an external storage device via a host, comprises the steps of: providing an external storage device comprising a memory device, wherein the memory device comprises one or more protected areas for storing an authentication application, and a reserved area for storing authentication information; and performing an identification request from an authentication application to allow the host to access the protected area of the external storage device when the authentication information is confirmed.

According to the present invention, an external storage device of controlling an access to a host comprises a reserved area for storing authentication information, and a processing unit. The processing unit is used for performing an identification request from the authentication application, and for allowing the host to access the protected area of the external storage device when the authentication information is confirmed.

The present invention will be described with reference to the accompanying drawings, which show exemplary embodiments of the present invention.

### BRIEF DESCRIPTION OF THE DRAWINGS

FIG. 1 shows a functional block diagram of an external storage device and a host according to a preferred embodiment of the present invention.

FIG. 2 is a schematic diagram of the memory device, the single chip and the host of the storage device

### DETAILED DESCRIPTION OF THE INVENTION

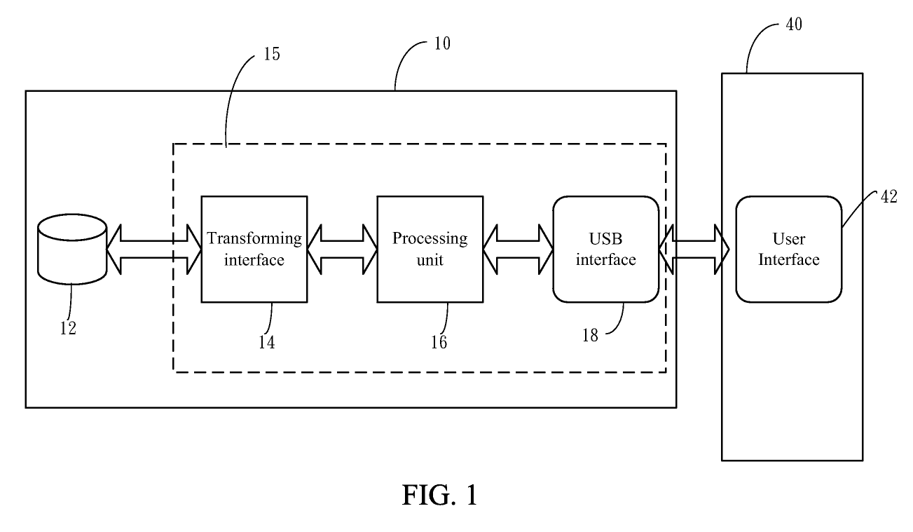

Please refer to FIG. 1, FIG. 1 shows a functional block diagram of an external storage device 10 and a host 40 according to a preferred embodiment of the present invention. The external storage device 10 comprises a memory device 12, a transforming interface 14, a processing unit 16, and a universal serial bus (USB) interface 18. The host 40 may be a desktop computer, a notebook computer, an industry computer, a recordable DVD player, and so on. The memory device 12 may be a hard disc drive or a flash memory. The transforming interface 14 may be an ATA/SATA interface or a flash memory interface for transforming data stored in the memory device 12 into ATA/SATA format or data format accessible to the flash memory. The processing unit 16 is used to code/decode the transformed data, and to deliver the coded/decoded data to the USB interface 18. Then, the coded/decoded data is sent to the host 40 via the USB interface 18. The transforming interface 14, the processing unit 16, and the USB interface 18 may be integrated in a single chip 15 or respective chips.

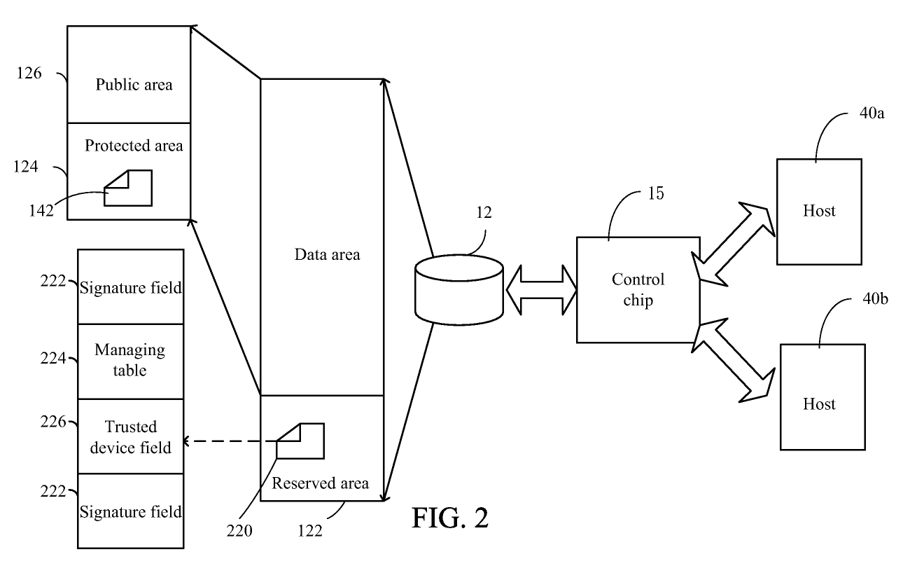

Please refer to FIG. 2. FIG. 2 is a schematic diagram of the memory device 12, the single chip 15 and the host 40 of the storage device 10. The memory device 12 comprises a data area and a reserved area 122. The data area stores general data and the reserved area 122 stores authentication information 220. The data area comprises one or more protected areas 124 and a public area 126. The reserved area 124 and the public area 126 store data of various confidential levels according to its priority and confidentiality, respectively. For example, a data in the public area 126 can be non-confidential and unlocked data which is access to the host 40 by the one owning the external storage device 10. The data in the protected area 124 is so confidential as to be accessed after verification by a specific authorizing password. The confidential level of the data can be determined by the user, depending on which area the data is stored in, the protected area 124 or the public area 126. In a preferred embodiment, when the user intends to access the data in the memory device 12 of the storage device 10 through the host 40, at first, the host 40 and the user's password has to be verified by the authentication information stored in the reserved area 122 before allowing access to the data in the protected area 124 or the public area 126. Moreover, the protected area 124 can store an authentication application 142, which is a software program code. The processing unit 16 executes the authentication application 142 to verify the authorizing password or the authentication information 220.

Please keep referring to FIG. 2. The authentication information 220 in the reserved area 122 comprises a signature field 222, a managing table 224 and a trusted device table 226. The signature field 222 comprises an OEM ID field and a software revision field. After the operating system of the host 40 initiates, the host 40 reads the OEM ID to confirm the manufacturer and the type of the storage device 10. The software revision field records the revision of the software program run by the storage device 10. In other words, the operating system of the host 40 determines the state of the hardware and software of the storage device 10 by identifying the OEM ID field and the software revision field. The managing table 224 records the start logical block addresses and the storing sizes for data of the protected area 124 and the public area 126, so that the operating system of the host 40 knows the space for storing data in the memory device 12. Also, the trusted device table 226 of the authentication information 220 records one or more specific information and corresponding authorizing passwords of the host 40. The specific information is used for verifying the uniqueness of the host and therefore it can be the MAC address of the host 40, a serial number of the software revision of the operating system in the host 40, the OEM ID of the motherboard of the host 40, or a combination thereof. The trusted device table 226 additionally records the authorizing password, an allowable use count of the authorizing password, and a valid period of the authorizing password indicating its' expiration date.

When the storage device 10 plugged into an untrusted host 40a in the first time, the operating system of the host 40a begins with determining the authentication information 220 of the reserved area 122. By reading the OEM ID field and the software revision field of the signature field 222, the host 40a identifies the manufacturer and types of the storage device 10 and its software revision. However, because of the host 40a's first access to the storage device 10, the trusted device table 226 of the reserved area 122 does not have the specific information of the host 40a and its corresponding authorizing password. Consequently, after the user, through a user interface 42 of the host 40, inputs and confirms an authorizing password, the user can access the data in the protected area 124 for instance. It is noted that, before the authorizing password is entered and verified, the user can not access the data in the protected area 124 through the host 40a. At the same time, the user can set the use count and the valid period of authorizing password through the user interface 42 or the authentication application 142. For example, the user can set the allowable use count of the authorizing password as 10 times and its valid period as 7 days. That is, if the user connects the storage device 10 to the host 40a within 7 days, since the use count of the authorizing password is less than 10 times and the valid period is 7 days, the operating system of the host 40a, based on the use count and the valid period of the authorizing password in the trusted device table 226, determines the authorizing password as valid. Therefore, the user can access the data in the protected area 124 of the storage device 10 through the host 40 without entering the authorizing password again. But, if the user attempts to access the storage device 10 through another host 40b, the authorizing password exclusive to the host 40a and its corresponding use count and valid period are invalid altogether. As a result, the user has to set another authorizing password, its use count and valid period of the host 40b exclusively. Of course, if the storage device 10 accesses the host 40a by its authorizing password over 10 times, or the valid period, 7 days, has expired, the authorizing password exclusive to the host 40a becomes invalid and the user has to re-set a password. It is noted that there is a confinement of the valid period and use count in accessing the storage device 10 in the untrusted host 40a.

After the host 40a successfully accesses the protected area 124, the storage device 10 stores the specific information and the authorizing password of the host 40a in the reserved area 122 and labels the host 40a as authorized in a specific blank in the reserved area 122. Only through the authorized host 40a, the user enjoys the full authority to control the storage device 10. In other words, the host 40a becomes the trusted host from the untrusted host. After then, the user connects the storage device 10 to the host 40a, it is not required to enter the authorizing password again before accessing the data in the protected area 124 and that in the public area 126. Also, the user is allowed to change or even eradicate the data in the protected area 124 and that in the public area 126 with the host 40a. Besides, the user has the power to set the use count and the valid period of the authorized password with the user interface 42 or the authentication application 142. For example, the user can set the allowable use count of the authorizing password as 20 times and its valid period as 14 days. That is, if the user connects the storage device 10 to the host 40a within 14 days, since the use count of the authorizing password is less than 20 times and the valid period is 14 days, the operating system of the host 40a, based on the use count and the valid period of the authorizing password in the trusted device table 226 of the authentication information 220, determines the authorizing password as valid. Therefore, the user can access or even modify the data in the protected area 124 and that in the public area 126 of the storage device 10 through the host 40 without entering the authorizing password again.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. An external storage device of controlling an access to a host, comprising:
a memory device comprising:
one or more protected areas for storing an authentication application; and
a reserved area for storing authentication information; and
a processing unit for performing an identification request from the authentication application, and for allowing the host to access the protected area of the external storage device when the authentication information is confirmed.

2. The external storage device of claim 1, wherein the memory device is selected from the group consisting of a hard disc drive and a flash memory.

3. The external storage device of claim 2, wherein the memory device further comprises a transforming interface for transforming data stored in the hard disc drive into ATA/SATA format.

4. The external storage device of claim 1, wherein the authentication information comprises a managing table for recording start logical block addresses and storing sizes of the one or more protected areas.

5. The external storage device of claim 1, wherein the authentication information comprises a trusted device table for recording one or more specific information and corresponding authorizing passwords.

6. The external storage device of claim 5, wherein the specific information comprises MAC address of the host, a serial number of a software revision of an operating system in the host, an OEM ID of a motherboard of the host, or a combination thereof.

7. The external storage device of claim 5, wherein the processing unit is used for allowing the host to access the protected area of the external storage device when the authorizing password of authentication information is confirmed.

8. The external storage device of claim 5, wherein the trusted device table further comprises:
an allowable use count of the authorizing password; and
a valid period of the authorizing password indicating to an expiration date of the authorizing password.

9. The external storage device of claim 1, further comprising a public area for storing unlock data.

10. The external storage device of claim 1, further comprising a USB interface for transforming data from the processing unit into a USB format.

11. A method of controlling an access to an external storage device via a host, comprising:
providing an external storage device comprising a memory device, wherein the memory device comprises one or more protected areas for storing an authentication application, and a reserved area for storing authentication information; and
performing an identification request from an authentication application to allow the host to access the protected area of the external storage device when the authentication information is confirmed.

12. The method of claim 11, wherein the authentication information comprises a managing table for recording start logical block addresses and storing sizes of the one or more protected areas.

13. The method of claim 11, wherein the authentication information comprises a trusted device table for recording one or more specific information and corresponding authorizing passwords.

14. The method of claim 13, wherein the specific information comprises MAC address of the host, a serial number of a software revision of an operating system in the host, an OEM ID of a motherboard of the host, or a combination thereof.

15. The method of claim 14, wherein the trusted device table further comprises:
an allowable use count of the authorizing password; and
a valid period of the authorizing password indicating to an expiration date of the authorizing password.

16. An external storage device of controlling an access to a host, comprising:
a reserved area for storing authentication information; and
a processing unit for performing an identification request from the authentication application, and for allowing the host to access the protected area of the external storage device when the authentication information is confirmed.

17. The external storage device of claim 16, wherein the authentication information comprises a managing table for recording start logical block addresses and storing sizes of the one or more protected areas.

18. The external storage device of claim 16, wherein the authentication information comprises a trusted device table for recording one or more specific information and corresponding authorizing passwords.

19. The external storage device of claim 18, wherein the specific information comprises MAC address of the host, a serial number of a software revision of an operating system in the host, an OEM ID of a motherboard of the host, or a combination thereof.

20. The external storage device of claim 16, wherein the processing unit is used for allowing the host to access the protected area of the external storage device when the authorizing password of authentication information is confirmed.

21. The external storage device of claim 16, wherein the trusted device table further comprises:
an allowable use count of the authorizing password; and
a valid period of the authorizing password indicating to an expiration date of the authorizing password.

22. The external storage device of claim 16, further comprising a public area for storing unlock data.

23. The external storage device of claim 16, further comprising a USB interface for transforming data from the processing unit into a USB format.

24. The external storage device of claim 16, further comprising one or more protected areas for storing the authentication application.
